(19) United States
(12) Patent Application Publication
(10) Pub. No.: US 2007/0108315 A1
(43) Pub. Date: May 17, 2007

(54) Spray nozzle for cooling the piston of an internal combustion engine

(75) Inventor: Stefan Gehrig, Karistadt (DE)

Correspondence Address: KREMBLAS, FOSTER, PHILLIPS & POLLICK, 7632 SLATE RIDGE BOULEVARD, REYNOLDSBURG, OH, 43068, US

(73) Assignee: SCHMITTERGROUP AG, THUNGEN (DE)

(21) Appl. No.: 10/555,151

(22) PCT Filed: May 5, 2004
(86) PCT No.: PCT/EP04/50711

§ 371 Date: Dec. 29, 2006

(30) Foreign Application Priority Data
May 7, 2003 (DE) 103 20 576.4

(51) Int. Cl. B05B 1/34

(52) U.S. Cl. 239/490; 239/461; 239/492

(57) ABSTRACT

Spray nozzle for piston cooling of an internal combustion engine, whose cooling fluid outlet opening is formed with a discharge geometry which prevents the discharge of cooling fluid in an inner region lying within a hypothetical extension of the outlet opening and being surrounded by the cooling fluid otherwise being sprayed out, by a plurality of webs (10) penetrating the discharge cross-section of the outlet opening (15) in such a manner that the cooling fluid nozzle stream (12) being discharged fragments into individual partial jets (17), these being disposed around the inner region (7) being kept free of cooling fluid.

The invention relates to a spray nozzle for the piston cooling in particular of an internal combustion engine. This spray nozzle is the discharge opening for cooling fluid with a discharge geometry or discharge cross-section which prevents the discharge of cooling fluid into an inner region which lies within a hypothetical extension of the outlet opening and is surrounded by the cooling fluid otherwise being sprayed out.

When components in or on internal combustion engines are subjected to high thermal stresses, the use of cooling systems is necessary. As coolants, for example, cooling water or engine oil are used and supplied via channels. The internal combustion engine components are wetted with coolant also on their surfaces. This applies particularly to the piston heads in the internal combustion engine. Wetting can be effected by engine oil via a coolant channel of the piston. The oil applied absorbs the heat and flows back into the oil circuit, which is constantly cooled.

In order to achieve controlled cooling at the right place with a minimum quantity of oil, the coolant must hit the target location very accurately. In particular where coolant channels are used, a bundled jet of coolant is necessary. This can be realised with small nozzle diameters and a specially formed nozzle geometry in conventional internal combustion engines in whose oil circuit a pressure of approx. 2.5-5 bar prevails. In the case of high thermal stresses, an oil quantity of up to 10 kg cooling oil per minute per piston is required. In order to apply this quantity of oil, an injection tube with a large diameter is necessary. With this arrangement, a bundled coolant jet is not realisable with current nozzle shapes.

Also according to the patent specification DE 23 43 655 (Motoren-und Turbinen-Union Friedrichshafen GmbH), in supplying oil to the coolant chamber in the piston through an open jet nozzle fixed to the cylinder crankcase, it should be ensured that as a high cooling oil throughput from the open jet nozzle, an oil jet which is as bundled as possible is generated, which reaches a collection aperture on the piston in order that sufficient cooling oil throughput is achieved in the piston even in the upper dead centre position of the piston. In order to promote bundling of the oil jet, the use of a guide member formed as a cross on the inlet end of the nozzle in the direction of flow was claimed, but immediately rejected. The cruciform faces of the guide member placed transversely in the oil stream would so considerably restrict the passability of the supply bore in the nozzle for dirt particles, that total blockage of the nozzle could easily occur. The oil jet discharge end of this nozzle is realised at the end face by a simple cylindrical opening bore. The bundling of the cooling oil jet is in this case only achieved by the physical effect of cohesion between the individual oil droplets in the jet.

Also in EP-B-0 825 335 (PORSCHE), the problem is addressed of how to achieve controlled, bundled action on the piston and hence effective cooling by prevention of premature fanning out of the oil jet. To this end, use is made of plural opening channels extending in a nozzle end piece and parallel to one another. To promote bundling, controlled dimensioning of the opening channel diameter and of the spacing of the opening channels from one another are used. Ultimately, here too, one is referred to the physical effect of cohesion in order to achieve bundling of the emerging partial jets to form a full jet. This is also assisted by the proposed, relatively small spacing of the opening channels. The teaching of EP-B-0 057 790 (CATERPILLAR) is also based on a similar principle, according to which in a coolant nozzle a first cooling oil outlet of larger diameter is surrounded by a series of cooling oil outlets of smaller diameter arranged in a ring.

In WO-A-01/14699 (SCANIA), a coolant nozzle is disclosed for piston cooling wherein the premature fragmentation of the coolant jet is questioned, because it diverges from the desired circular-cylindrical form of the jet and would instead produce a conically widening jet. As a remedy, at the nozzle outlet, a coolant outlet aperture is proposed in the shape of a single, curved aperture slot with a U- or C-shaped profile, in order to prevent fragmentation of the jet. This is also intended, by the proposed form, to retain a compact state for a large distance. This is based on the claim that expansion of the jet inward, towards the central region of the curved cross-section, is made possible, and widening forces on the jet would be reduced. This is because, by means of an inner intermediate wall which separates opposing arms or sections of the U- or C-shaped aperture slot from one another, a low-pressure zone is created, around which the curved jet cross-sectional profile curves. To produce such a nozzle, the use of a mandrel for plastic deformation of a tubular blank is proposed. The tube walls must in this case be pressed against the mandrel in order to achieve adaptation to the mandrel cross-section. Accordingly, it should be difficult to separate the mandrel and plastically deformed nozzle tubular member from one another.

The object of the invention is to ease and simplify the manufacture of a generic spray nozzle and to further optimise the jet bundling whilst avoiding or overcoming the disadvantages of the prior art. To achieve this, the spray nozzle indicated in claim 1 is proposed. Optional, advantageous embodiments of this invention will appear from the dependent claims.

Since according to the invention the cooling fluid stream is fragmented into a plurality of individual partial jets inside the nozzle by means of the webs, these partial jets may be grouped in a common row around the (low-pressure) zone kept free of the cooling fluid jet and thus screen the low-pressure zone even better against ambient pressure. Thus in the low-pressure zone, even stronger reduction of the (low) pressure compared to atmospheric ambient pressure is achieved with the further consequence that the individual jets are “sucked” even more strongly into the low-pressure inner region and hence converge. These effectively increased forces according to the invention oriented towards the low-pressure inner region produce a tangible acceleration of bundling of the partial jets or re-combining thereof to form a full jet, with which the head or the like of an internal combustion engine piston can be precisely wetted and cooled at a specified point. Due to the nozzle outlet according to the invention, therefore, the cooling jet is at first intentionally fragmented. Due to the above-mentioned physical conditions, the individual partial jets are brought together again after discharge to form one very strong jet. With this method, the requirement for a “large volume flow and a small target area” is met.

The invention provides the further advantageous embodiment, that the thickness of the webs compared to the thickness or “diameter” of the individual partial jets can be minimised, so that the distances between adjacent partial jets also become minimal. The advantage achieved thereby consists in an even tighter screening of the low-pressure inner region compared to atmospheric pressure with a consequent further reduction in the pressure in the inner region. Via the option made available by the invention, of being able to use extremely thinly dimensioned webs in relation to the cross-sectional thickness of the partial jets, the targeted ideal structure for the cooling fluid full jet—closed annular jet cross-section—can be quite well approximated.

Simplification of the construction and manufacturing method can be generally achieved by structures which are as uniform or as symmetrical as possible. Thus an advantageous embodiment consists in that the webs—starting from the surrounding wall defining the outlet opening—extend towards the centre of the discharge cross-section, in particular with a cylindrical basic shape extend radially and meet or intersect with one another at that point. Alternatively, the webs may meet on a specially formed, e.g. disc-like inner part, via which the webs are connected. Thus a fragmentation insert, preferably in the shape of a cross or star, is achieved which is easy to handle or assemble and can be inserted rapidly in the nozzle outlet opening. In order to prevent the discharge of cooling fluid in the inner region defined by the partial jets as effectively as possible, it is advantageous to make the inner part sufficiently large with a diameter or span which exceed the thickness of the webs and make up at least a fifth of the thickness, of the diameter or of the otherwise cross-sectional span, which the outer contour or surrounding wall of the nozzle outlet opening includes.

A particularly economical method of manufacture is achieved if the jet fragmentation insert is manufactured as a single piece, e.g. by plastics injection moulding or the like and/or from sintered steel or another heat-and/or oil-resistant material, the inner part and the webs being connected together in one piece or being otherwise integral. Alternatively, it is within the scope of the invention to produce a separate inner part separately and then to hold the same by the webs bearing on the inner wall of the discharge opening.

According to an alternative embodiment of the invention, the webs do not, or at least do not all, need to extend to the interior of the cross-section of the outlet opening; to achieve the effects targeted with the invention, it is also conceivable that the webs extend as rectilinear or curved chords of a circular or otherwise round arc and thus define segments of a circle or other round segments. Thus it is conceivable that the low-pressure inner region/inner zone is defined by a series of partial jets having the shape of a segment of a circle, lying adjacent to one another in a ring. Since the associated chords formed by the webs may meet at their corners forming concave corners, with this special arrangement a particularly effective screening of the low-pressure inner zone/inner region can be achieved.

The invention is not only restricted to supporting any inner part by means of the webs with respect to the nozzle inner wall. Alternatively or in addition, the inner part, in particular in an elongate mandrel or stem shape, could be held from the nozzle interior, e.g. from the inlet of the nozzle, by means of a wire soldered in or the like.

The webs in the nozzle outlet opening inevitably produce a certain choking of the cooling fluid flow in the nozzle, and turbulence may arise within the flow. In order nevertheless to give the cooling fluid being discharged from the nozzle into the partial jets sufficient kinetic energy, according to an advantageous embodiment of the invention it is provided to connect upstream of the webs in the direction of flow means which accelerate the cooling fluid or increase its rate of flow.

Further details, features, combinations of features, effects and advantages on the basis of the invention will appear from the following description of preferred embodiments of the invention and from the drawings, which show:

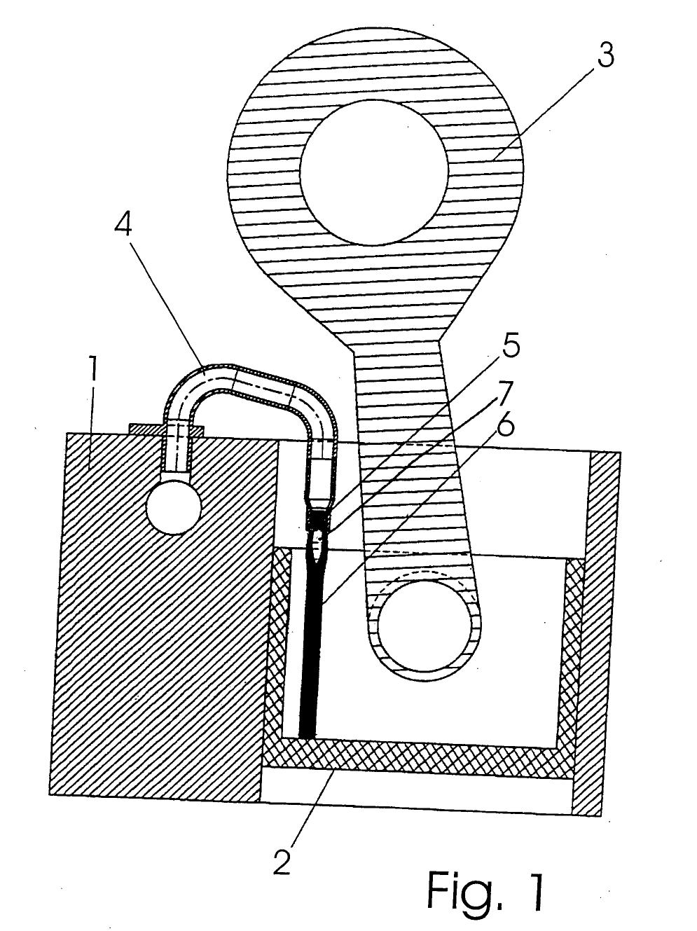

FIG. 1, a diagram of the arrangement of a spray nozzle for wetting an internal combustion engine piston, which is connected via a connecting rod to a crankshaft or the like;

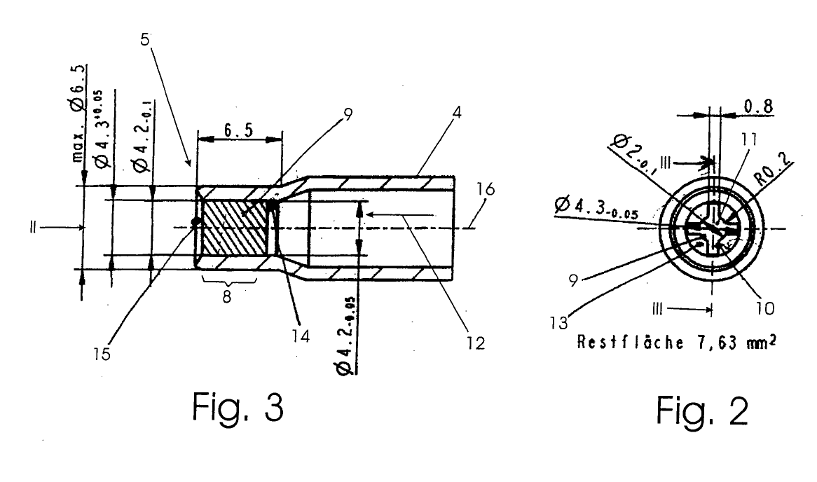

FIG. 2, an embodiment of the spray nozzle according to the invention in an end view in the direction II in FIG. 3;

FIG. 3, the spray nozzle in longitudinal section along the line III-III in FIG. 2;

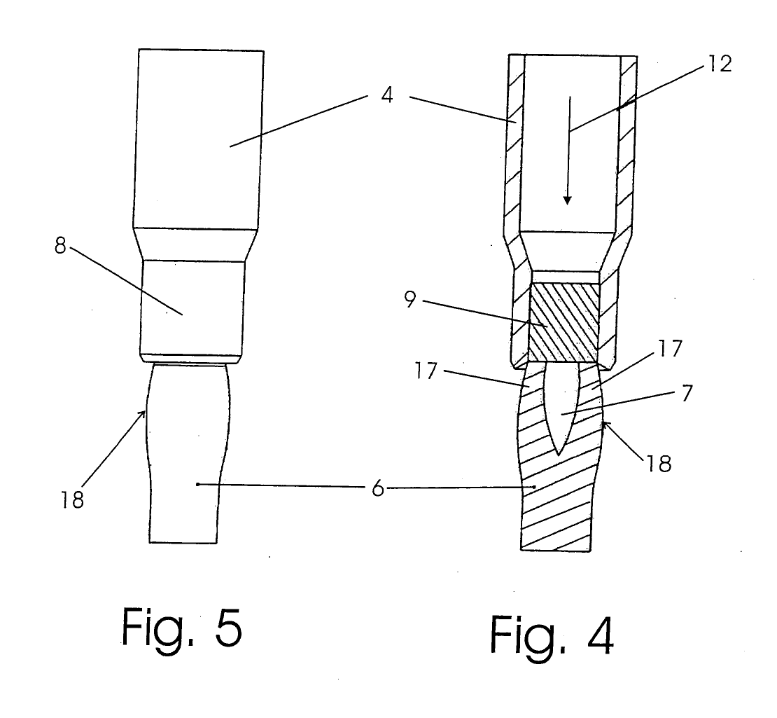

FIG. 4, a diagram corresponding to FIG. 3 with a jet longitudinal section; and

FIG. 5, a longitudinal view of the spray nozzle according to FIGS. 2-4.

According to FIG. 1, a piston 2 for carrying out stroke movements is linearly guided in an engine block 1 in a manner known per se. The piston strokes are, as is known per se, coupled to a crankshaft or the like via connecting rod devices 3 or the like. To cool the piston, a supply tube 4 for cooling fluid, e.g. engine oil, leads from the engine block 1 and extends in the direction of the piston 2. The supply tube 4 has in its end associated with the piston 2 the spray nozzle 5 according to the invention, from which a composed full jet 6 of cooling fluid is sprayed with a low-pressure region 7 directly adjoining the nozzle outlet.

According to FIGS. 2 and 3, in the free end region of the supply tube 4, the spray nozzle 5 according to the invention is realised with a tapered tube section 8, in which a cruciform fragmenting insert 9 is located. This, as can be seen particularly from FIG. 2, can be structured like a cross in four radial webs 10 and a central inner part 11, to which the webs 10 are joined. The outer contour of the inner part 11 between two respective webs 10 is formed with a radius of e.g. 0.2 mm, so that approximately a disc shape is imparted to the inner part 11. According to the embodiment shown, the round inner part 11 has a diameter of about 2 mm, whilst the inner diameter of the tapered tube section 8 is about 4.3 mm. Thus a residual discharge area of about 7.63 mm² is produced for the coolant flowing through the tapered tube section 8 in the flow direction 12. Further, purely exemplary measures are indicated in FIGS. 2 and 3. By a tube section taper 8 effected in the cooling fluid flow direction 12 to about 4.2 mm inner diameter, the potential pressure energy in the tube section with a larger diameter is converted into additional kinetic energy. Thus an increase in the flow rate or additional acceleration is imparted to the cooling fluid which is sprayed out in corresponding partial jets within the four discharge sectors 13. The discharge sectors 13 are defined by the round outer contour of the inner part 11, respective adjacent webs 10, and the hollow-cylindrical inner wall 14 of the nozzle discharge opening 15. The central axis 16 of the nozzle tube section 8 extends roughly congruently with the position of the centre point of the fragmentation insert 9. According to the embodiment of FIG. 2, the thickness of the web is about 0.8 mm and thus makes up less than a fifth of the diameter of the discharge cross-section or discharge opening 15 of the spray nozzle 5. Thus the distances between the individual cooling fluid discharge sectors 13 in the tube circumferential direction are kept small enough as sufficiently to define the low-pressure inner region 7 with respect to the surroundings at atmospheric pressure.

The formation of the combined full jet 6 from individual partial jets 17 corresponding to the discharge sectors 13 is illustrated in FIG. 4. The partial jets 17 are disposed around the inner region 7 of low pressure kept free of cooling fluid and converge more the further the distance from the spray nozzle 5 or its fragmentation insert 9, until the partial jets 17 are combined into the full jet 6. This is effected, viewed in the flow direction 12, after the low-pressure inner region 7, which ends where combining of the partial jets starts. According to the invention therefore, when the cooling fluid stream leaves the nozzle by means of the fragmentation insert 9, it is first fragmented into the individual partial jets 17. By the central low-pressure region 7 kept free of cooling fluid, the individual partial jets are brought together to the very strong full jet after discharge. Further marked is a bulge 18 of the outer jet contour, which is ascribable to the inherent tendency of the jet to diverge. This is compensated by the low-pressure inner region 7, which makes stronger forces develop on the cooling fluid jet which are oriented into the jet interior. In the longitudinal view in FIG. 5, the individual partial jets are not shown, because these would not be visible to the human eye in reality.

### LIST OF REFERENCE NUMBERS

1 engine block
2 piston
3 connecting rod device
4 supply tube
5 spray nozzle
6 cooling fluid full jet
7 low-pressure zone/region
8 tapered tube section
9 fragmentation insert
10 webs
11 inner part
12 flow direction
13 discharge sectors
14 inner wall
15 discharge opening
16 central axis
17 partial jet
18 bulge

1. A spray nozzle (5) for cooling the piston of an internal combustion engine, whose cooling fluid outlet opening (15) is formed with a discharge geometry which prevents discharge of cooling fluid in an inner region (7), which lies within a hypothetical extension of the outlet opening (15) and is surrounded by cooling fluid which is otherwise being sprayed out, characterised by a plurality of webs (10) penetrating the discharge cross-section of the outlet opening (15) in such a manner that fragmentation of the cooling fluid nozzle stream (12) being discharged takes place into individual partial jets (17), which are disposed around the inner region (7) being kept free of cooling fluid.

2. A spray nozzle (5) according to claim 1, characterised in that the webs (10) extend rectilinearly.

3. A spray nozzle (5) according to claim 1, characterised in that the thickness of the webs (10) is minimised to the extent that the cooling fluid partial jets (17) extending next to one another approximately produce the effect of a full jet cross-section which has a closed annular form.

4. A spray nozzle (5) according to claim 3, characterised in that the thickness of the web (10) makes up a quarter maximum of the thickness, of the diameter or other cross-sectional span, which the outer contour or surrounding wall (14) of the nozzle outlet opening (15) includes.

5. A spray nozzle (5) according to claim 4, characterised in that the webs (10) extend to the centre of the discharge cross-section and meet or intersect there.

6. Spray A spray nozzle (5) according to claim 1, characterised in that the webs (10) extend to the centre of the discharge cross-section and there meet on an inner part (11) which joins the webs (10), forming or arranging a cross- or star-shaped jet fragmentation insert (9).

7. A spray nozzle (5) according to claim 6, characterised in that the inner part (11) is formed with a diameter or span which exceeds the thickness of the webs (10).

8. A spray nozzle (5) according to claim 6, characterised in that the inner part (11) is formed with a diameter or span which makes up at least a fifth, of the thickness, of the diameter or other cross-sectional span, which the outer contour or surrounding wall of the nozzle outlet opening (15) includes.

9. A spray nozzle (5) according to claim 8, characterised in that with the jet fragmentation insert (9), the inner part (11) and the webs (10) are incorporated or connected together in one piece.

10. A spray nozzle (5) according to claim 6, characterised in that the inner part (11) is separately manufactured and is held by the webs (10) supported against the discharge opening (15).

11. A spray nozzle (5) according to claim 6, characterised in that the webs and/or the fragmentation insert are received in the opening end of a nozzle tube part, whose central axis is congruent with the inner part or point of meeting or intersection of the webs.

12. A spray nozzle (5) according to claim 6, having a round nozzle tube part, characterised in that the webs are arranged as limits of free sectors of a circle and/or segments of the discharge cross-section.

13. A spray nozzle (5) according to claim 6, characterised by means, disposed upstream of the webs (10) in the flow direction (12), of accelerating the cooling fluid or of increasing the cooling fluid flow rate.

14. A spray nozzle (5) according to claim 13, characterised by a nozzle tube part, which tapers in the flow direction (12) of the cooling fluid and has the webs (10) at the end of this tapered tube section (8).

15. Spray A spray nozzle (5) according to claim 14, characterised in that the webs (10), the fragmentation insert (9), and the inner part (11) are manufactured from sintered steel and/or plastics material.

16. A spray nozzle according to claim 2, wherein the webs extend to the centre of the discharge cross-section and intersect there forming a cross or star-shaped jet fragmentation insert having an inner part with a diameter or span which exceeds the thickness of the webs, the thickness of the webs being less than a fifth of the span of the discharge cross-section of the outlet opening.

17. A spray nozzle according to claim 16 wherein the nozzle includes a nozzle tube part having the cooling fluid outlet opening at an outlet end in which the insert is mounted, the nozzle tube part tapering in the flow direction of the cooling fluid upstream of the insert.
